(19) United States
(12) Patent Application Publication
(10) Pub. No.: US 2024/0135330 A1
(43) Pub. Date: Apr. 25, 2024

(54) SYSTEM AND METHOD FOR CONNECTING CONTACTS WITH EMPLOYERS AND TRACKING REFERRALS

(71) Applicant: Bruno A. Stanziale, Fair Haven, NJ (US)

(72) Inventor: Bruno A. Stanziale, Fair Haven, NJ (US)

(21) Appl. No.: 18/489,612

(22) Filed: Oct. 17, 2023

Related U.S. Application Data
(60) Provisional application No. 63/417,553, filed on Oct. 19, 2022.

(51) Int. Cl. G06Q 10/1053; G06Q 30/0273; G06Q 50/00

(52) U.S. Cl. CPC G06Q 10/1053; G06Q 30/0273; G06Q 50/01

(57) ABSTRACT

An automated referral tracking system for a customer to track job applicants referred to the customer by referral sources. The automated referral tracking system includes a computer or cloud-based processing device configured to create a customer account for the customer. The customer account is associated with a job listing and social media accounts, and a distributor account for each referral source. The system posts the job listing from the customer's account to job candidates on vineyard or on social media venues and customer accounts on those venues. It then tracks distribution of the posted job listing to identify the distributor social media account or one or more social media accounts they have integrated that distributed the posted job listing. Once a posted job listing has been filled by a job candidate, it then compensates each distributor account identified to have distributed the posted job listing filled by the job candidate or if the hire is made directly by vineyard platform customer pays vineyard all of the commission on the job.

### CROSS-REFERENCE TO RELATED APPLICATIONS

This application claims the benefit of priority of U.S. Provisional Application Ser. No. 63/417,553 filed on Oct. 19, 2022, the entire content of which is relied upon and incorporated herein by reference in its entirety.

### BACKGROUND

Currently in the job-posting market, there is no platform where employers/companies can leverage their own social network of followers to reach more candidates for their job openings Most companies only leverage and incentivize through an employee referral network. Although job links can be shared to the employee's friends and networks, there is no formal incentive. There is an opportunity to leverage these companies' existing robust social media follower network to expand the search for viable candidates, and with an added formal incentive structure, this should enable better quality leads/candidates that's more cost-effective and productive vs going through external recruitment etc.

### SUMMARY

It is therefore one object of the disclosure to provide a platform that connects the company (“Customer”), their direct followers on social media (“Harvesters”) and their direct network to reach job Applicants (“Grapes”). It is a further object to provide a browser and mobile optimized front-end portal for Customer (company), Harvester (distributor), and Grapes (Applicants) to create accounts, Login, profile information etc. and allow the Customer to create jobs (manually, or via integration through an Applicant Tracking System (ATS), or AI engine looks for the potential Harvesters). And to provide Social Media Integration, including to allow Customers to send job links to social media and/or Harvesters, and assume that the “deal” between Customers and Harvesters could be done before an initial link is distributed (existing deal or connection) and can be formed through the initial click on the job link as a direct social media follower of the Customer. The Harvester will be able to distribute link through their social network, becoming the originator after the initial posting. Applicants can click on a link to apply for job on the platform, and given the option to generate a link to further distribute, and to create a Harvester account.

It is a further object of the disclosure to provide End-to-End Tagging/tracking to identify links to specific Harvester originators till the final successful candidates for accurate referral payout later. And, to provide a payment gateway integration for referral incentive distribution to Harvesters. And, to provide reporting capabilities, including tracking Job posts, Harvesters, Applicants, etc. (also includes insights, success rates, views, applications, etc.).

It is still a further object of the disclosure to build a platform with robust data tracking to enable companies to leverage their organic social network to connect jobs to candidates. And, provide User Interface (UI) and Front-end portal development, integration into social media, data tagging and management, reporting for analytics to providing meaningful and actionable insights and incentive payment distribution, and integration to payment gateways.

In certain embodiments, the system avoids and/or prevents deals or links connecting a Customer to a Harvester that's done “offline”, or outside initial job posting link via social media. And, avoids and/or prevents any payment deposit account management from company to vineyard for later distribution to Harvesters (could be how company pays vineyard etc.

In other embodiments, the system uses a cloud provider for quick environment setup and easier for integration. OSS is used, rather than a paid solution. The same technology is used for the Front End (FE) and the Back End (BE) to utilize developer resource (NodeJS). Dynamics adapt with others technical stack. A Separate Operation database and Reporting database (OLTP & OLAP) is utilized. And, the system implements DevOps for better product quality and reduce time-to-market.

This summary is not intended to identify all essential features of the claimed subject matter, nor is it intended for use in determining the scope of the claimed subject matter. It is to be understood that both the foregoing general description and the following detailed description are exemplary and are intended to provide an overview or framework to understand the nature and character of the disclosure.

### BRIEF DESCRIPTION OF THE FIGURES

The accompanying drawings are incorporated in and constitute a part of this specification. It is to be understood that the drawings illustrate only some examples of the disclosure and other examples or combinations of various examples that are not specifically illustrated in the figures may still fall within the scope of this disclosure. Examples will now be described with additional detail through the use of the drawings, in which:

FIGS. 1(a), 1(b) are block diagrams of the system;

FIGS. 2(a), 2(b) are flow diagrams for the system;

FIGS. 3(a)(1)-3(a)(3), 3(b), 3(c) are screen shots of the system;

FIGS. 4(a), 4(b)(1), 4(b)(2), 4(c), 4(d) are screen shots of the system; the Harvester asset leaderboard (FIG. 4(b)(1)) is found at the campaign asset level for each client, and shows the harvester assets distributing and their success in getting in grape assets;

FIGS. 5(a), 5(b), 5(c), 5(d) are screen shots of the system; and

FIGS. 6(a)-6(c) show workflow diagrams.

The figures show illustrative embodiment(s) of the present disclosure. Other embodiments can have components of different scale. Like numbers used in the figures may be used to refer to like components. However, the use of a number to refer to a component or step in a given figure has a same structure or function when used in another figure labeled with the same number, except as otherwise noted.

### DETAILED DESCRIPTION

In describing the illustrative, non-limiting embodiments illustrated in the drawings, specific terminology will be resorted to for the sake of clarity. However, the disclosure is not intended to be limited to the specific terms so selected, and it is to be understood that each specific term includes all technical equivalents that operate in similar manner to accomplish a similar purpose. Several embodiments are described for illustrative purposes, it being understood that the description and claims are not limited to the illustrated embodiments and other embodiments not specifically shown in the drawings may also be within the scope of this disclosure.

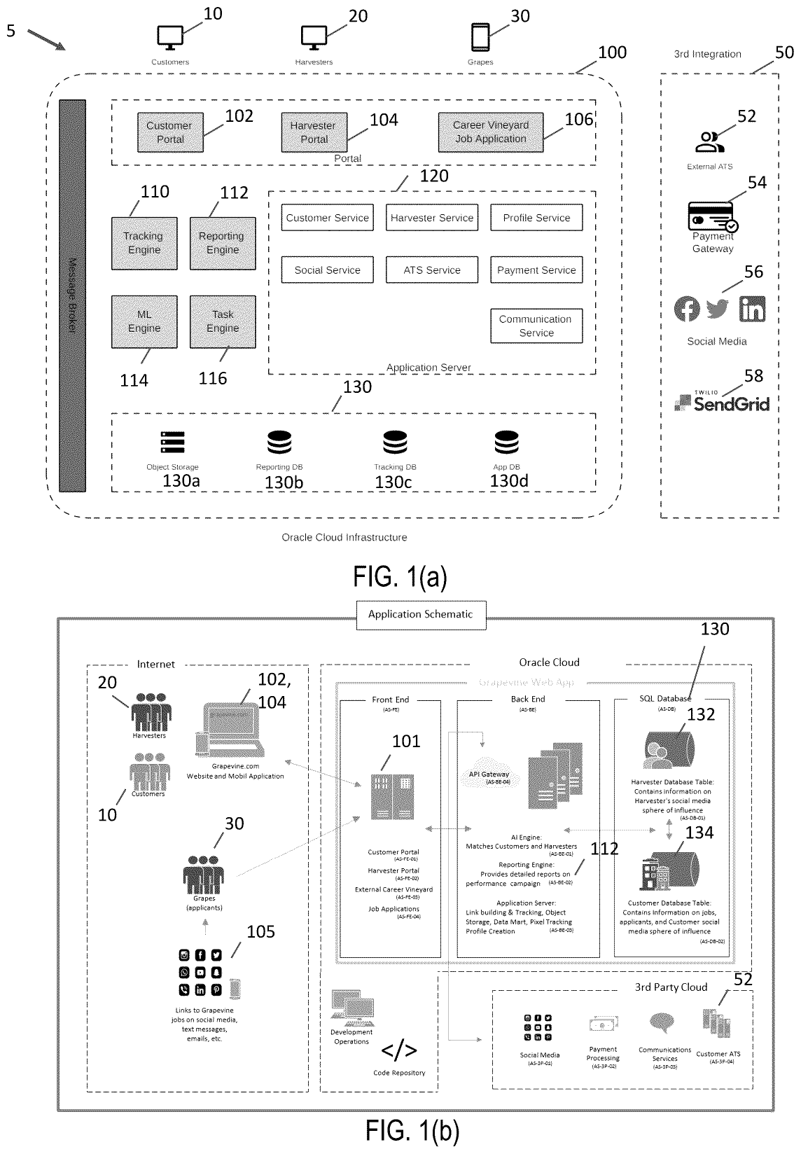

Turning to the drawings, FIGS. 1(a)-1(b) show the system 5 in accordance with one non-limiting illustrative embodiment of the disclosure. The system 5 has three types of users, namely Customers 10, Harvesters or Distributors 20, and Applicant Assets 30. The Customer user 10 is an entity (e.g., company or Employer) that is looking for a Candidate or potential Candidate Asset 30 (e.g., Employee, job Applicant or candidate, or asset owner/operator). And, the Harvester or Distributor user 20 is an entity (e.g., individual, such as a social media blogger, marketer, or social media influencer).

The system 5 includes a main infrastructure 100 that is in communication with various third party provider systems, including one or more external Applicant Tracking Systems (ATS) 52, one or more payment gateways 54, one or more social media platforms 56 (e.g., FACEBOOK, TWITTER, LINKEDIN), and one or more campaign management tools 58 such as SENDGRID. The ATS, or Applicant Tracking System, can be, for example, third party software that manages candidates and employees for their full life cycle within a company from application, to hire, to offboarding. Any suitable ATS can be utilized, such as for example, iCims, Oracle, Greenhouse, Bamboo HR, Workday etc. The infrastructure 100 includes a Customer portal 102, Harvester portal 104, and a Candidate asset portal 105 (FIG. 1(b)). The career vineyard job application 106 can include career vineyard and job application information, and can be viewed by any of the Customer 10, Harvester 20, and candidate 30.

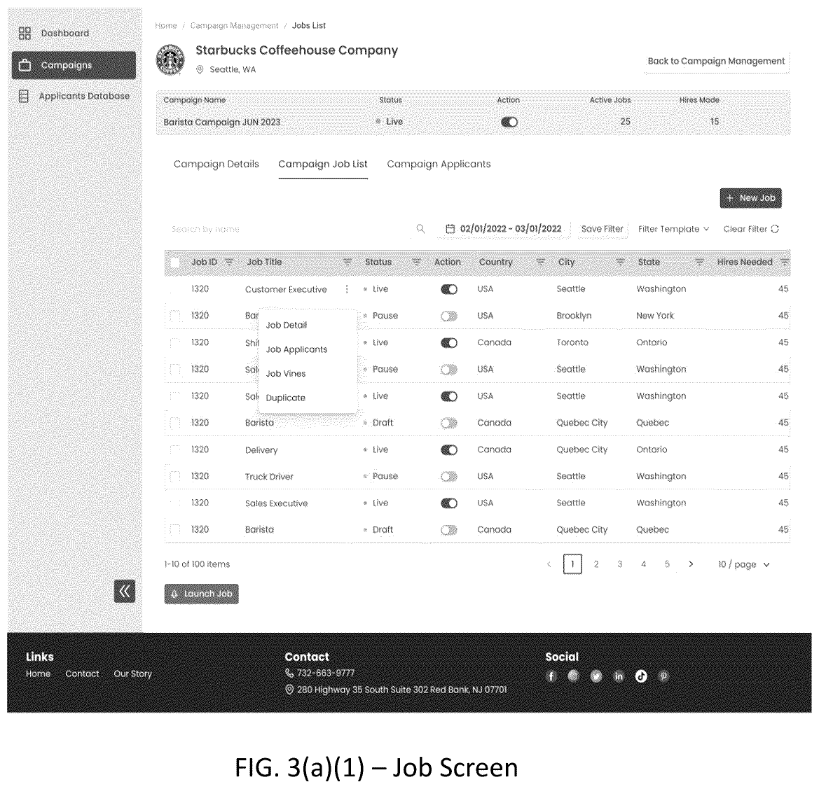

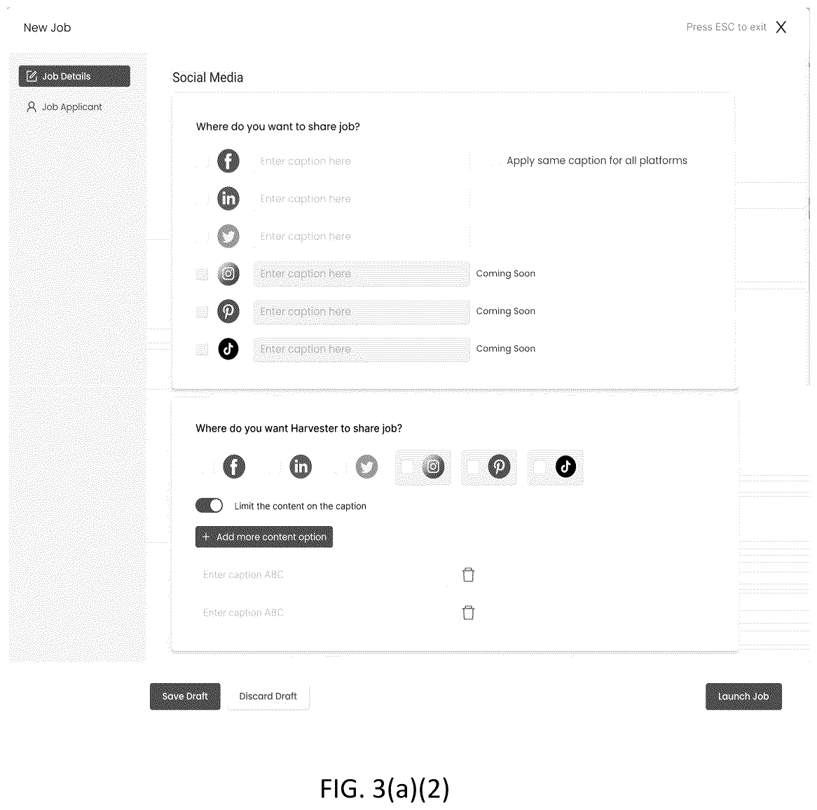

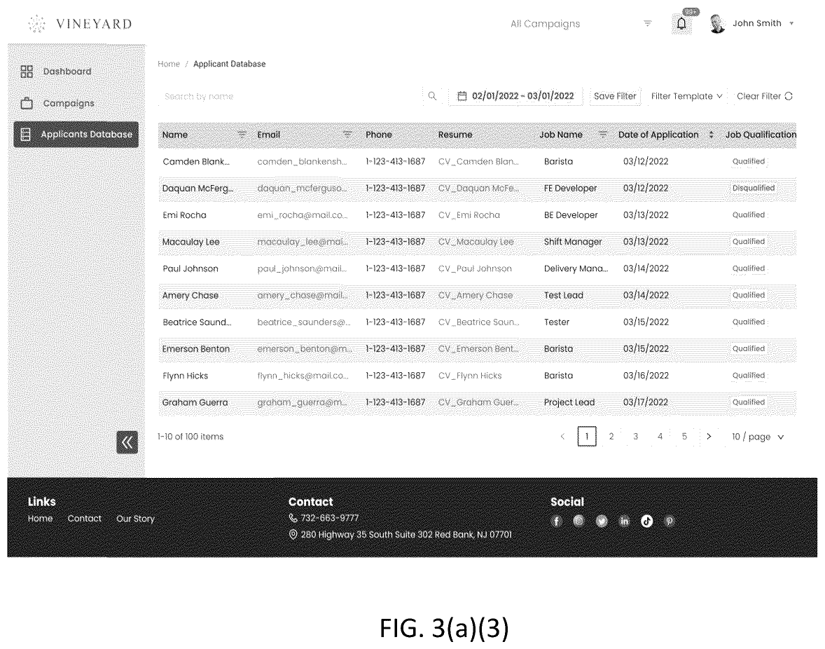

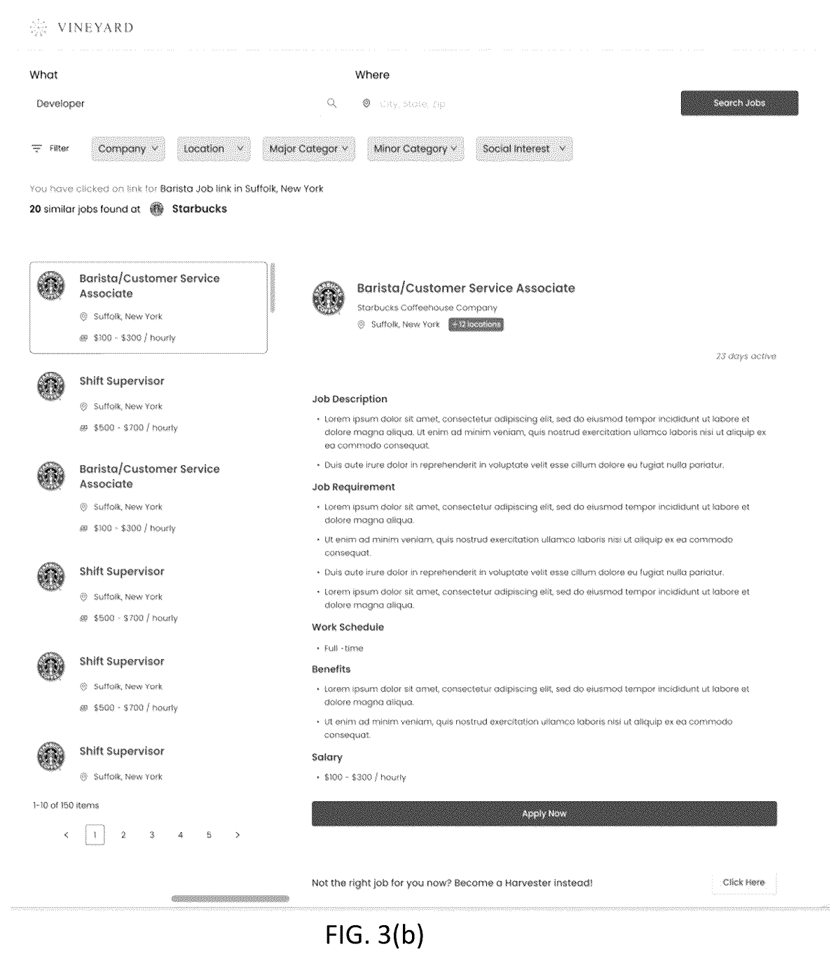

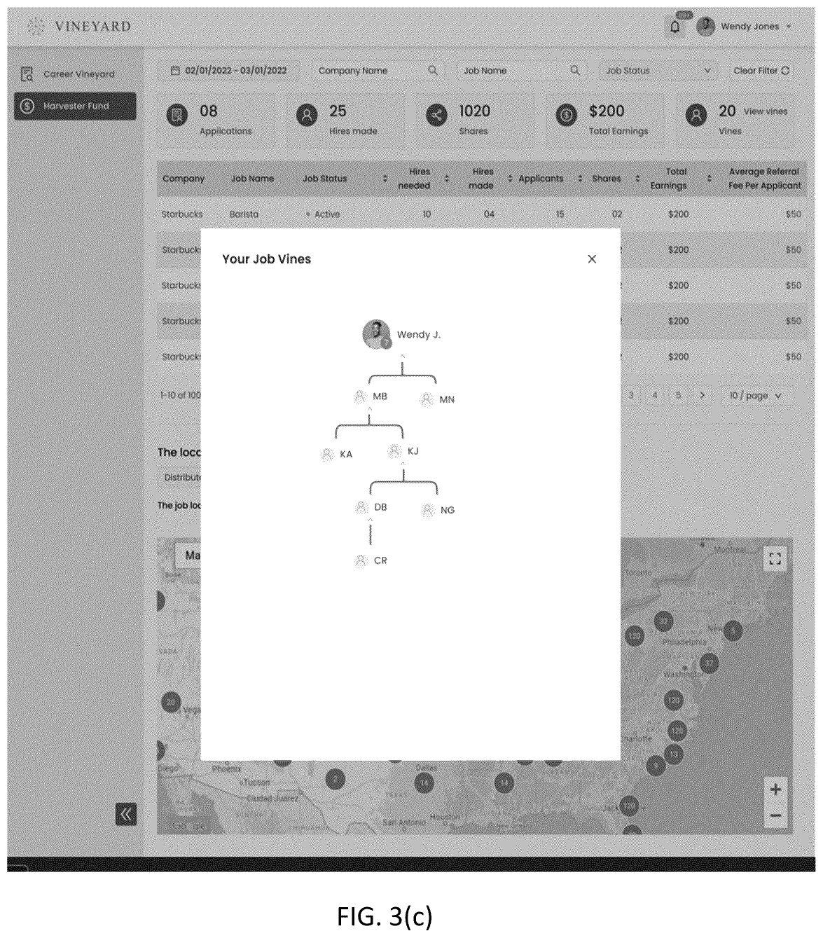

The application page 106 is the job application page, which shows to harvester assets 20 and applicant or candidate assets 30. This is where they physically fill out the application for the job that has been rehypothecated through the process. The end result is accessible by the client, as in they will receive an application. It is not something a customer asset 10 interacts with. Same is the case for the harvester portal 104. This portal 104 is used more specifically for a harvester asset 20 to track their applies, their rehypothecations, their hires, their payment etc. Candidate assets 30 do not have a specific portal. There is no concept of profile, therefore it is simply they apply to a job either through customer assets social media efforts, or rehypothecated efforts of the harvester asset. The vineyard is shown in FIG. 3(c). The career vineyard is something that a candidate asset 30 or applicant is directed into from various social media venues. This career vineyard can be either the customer assets career vineyard or basically a listing of all their jobs, or the harvester assets career vineyard. Candidate assets 30 are directed into either depending on which asset (customer or harvester) post they interact with.

The career asset portal 106 is where the Applicant can go after they have filled out an application to a specific job that has been shown to them by a Harvester. A job Applicant can only see the career vineyard of a Harvester that they have been shown a job from or a company specific career vineyard to which they have applied to one of that companies' specific jobs. For example, a job Applicant can apply for a job after shown a link by a Harvester, access that specific Harvester's career vineyard or the career vineyard specific to the company to which they have applied. A Harvester can access any job that the system is serving but the Customer can only access their jobs and the job Applicant can only access the jobs of a company to which they applied and the specific jobs that a Harvester sent them and to which they have applied. The portals 102, 104, 106 allow the respective users 10, 20, 30 to interface with the infrastructure 100. The main infrastructure, as well as the portals 102, 104, 106, can be, for example, a processing device such as a smart phone or computer that is in communication with a global database such as the Internet.

When a user accesses the portal 102, 104, 106 for the first time, the user selects the type of user, namely a Customer user 10, distributor user 20, and/or asset user 30. The user also provides biographical information (e.g., first name, last name), account access information (e.g., username, email, password), company information (e.g., company name, company website, company address), and social media account information (e.g., URL or handle for Facebook, Twitter, LinkedIn, Youtube, Instagram, Pinterest, and/or Tiktok). The user can also link any financial account information, such as for example a bank account, Venmo, and/or credit card and set up stripe payments account etc. An account is created for that user and is associated with the user type, biographical information, company information, social media information, and/or financial account information, and stored in the database 130. The database 130 can, for example, store all information that is collected by the system, including the Customer asset 10, Harvester asset 20 and the job Applicant asset 30.

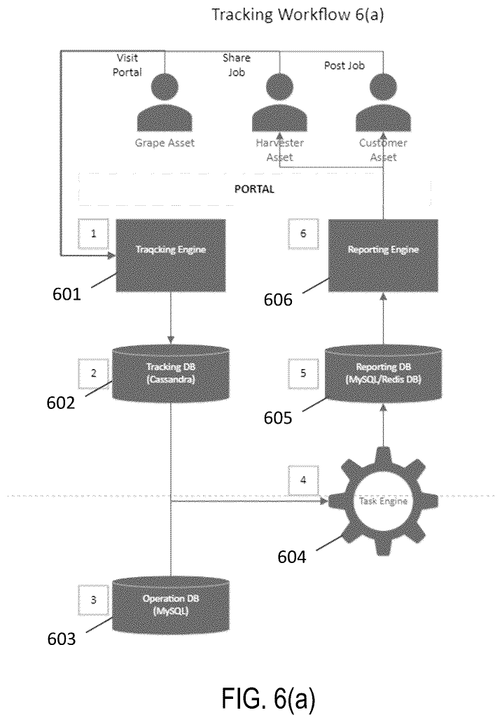

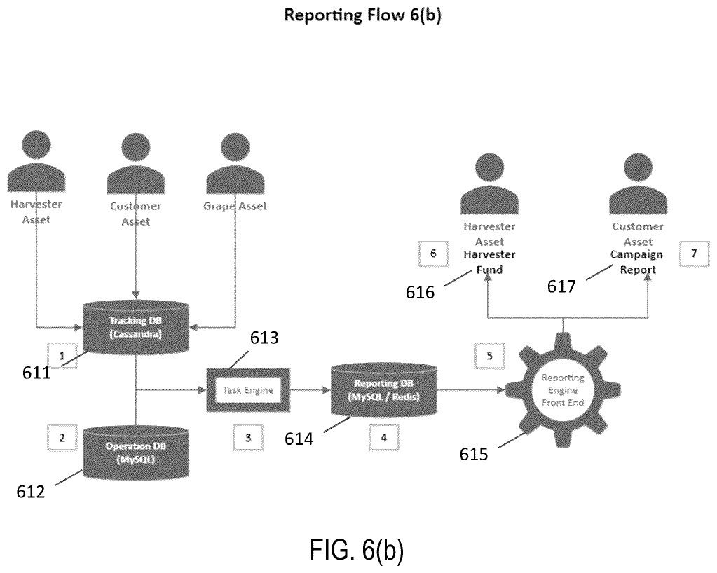

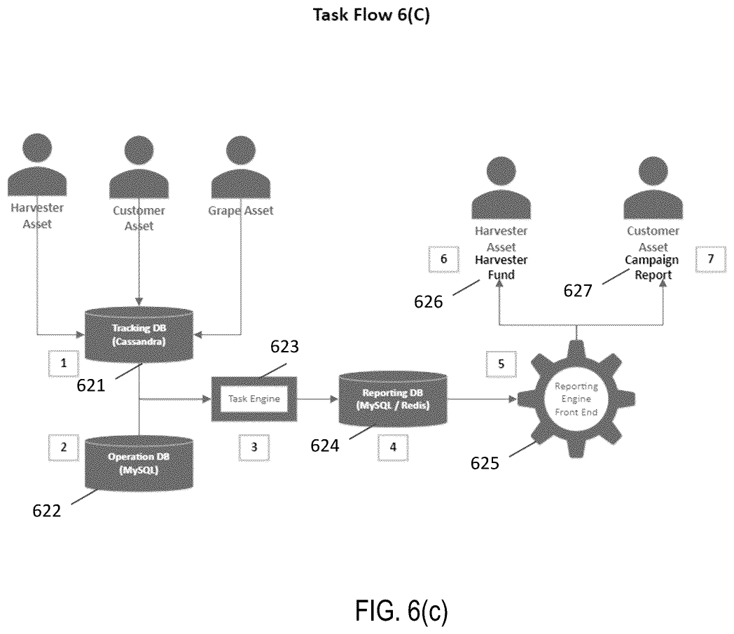

The infrastructure 100 also includes one or more engines or modules, including for example a tracking engine 110 (see also FIG. 6(a)), reporting engine 112 (see also FIG. 6(b)), Machine Learning engine 114, and the task engine 116 (see also FIG. 6(c)). The task engine 116 (see also FIG. 6(c)) can be any suitable engine, such as for example Celery. The task engine 116 (see also FIG. 6(c)) queues tasks. Basically, the system receives a signal to trigger something, and the task engine 116 (see also FIG. 6(c)) prioritizes that appropriately. The infrastructure 100 also includes an application server 120 that includes a Customer service module, Harvester service module, profile service module, social service module, ATS service module, payment service module, and communication service module. These modules are the code specific to managing the functions and features for each of the respective participants experiences within the system. The infrastructure 100 has one or more storage devices 130 such as for example an object storage, reporting database, tracking database and application database. Information generated or used by the various service modules 120 can be stored in and/or retrieved from one or more of the storage devices 130.

The tracking engine 110 (see also FIG. 6(a)) tracks all aspects of job placement and distribution through the social network. The reporting engine 112 (see also FIG. 6(b)), stores and retrieves information to/from the reporting database of the storage device 130, and generates all reports and alerts that can be standard or bespoke custom reporting on demand, meaning if customer asset needs a specific report the system can generate it. to create data rich graphs and charts around number of Applicants per job, average cost to hire, time to hire, conversions to hire etc. The Machine Learning engine 114 houses the data and structure by which the system learns to optimize distribution of jobs, increased applications and hires. Thus, the Machine Learning engine (tensor flow) is prescriptive for all users—Customer asset 10, Harvester asset 20 and Applicant asset 30. Thus, the system determines based on job categorization and response in our system where the customer is best to place their social media posts relating to their jobs. Which audience on which platform has the best interaction overall and generates the best results based on our system thus far.

FIG. 6(a) shows tracking engine flow, FIG. 6(b) shows reporting database workflow, and FIG. 6(c) shows task database workflow. Those operations can be performed, for example, by the task engine 116 (see also FIG. 6(c)). The task engine 116 (see also FIG. 6(c)) handles scheduling and data collection tasks inherent in the system that the users do not see. The task engine 116 (see also FIG. 6(c)) and the services 120, are behind the scenes workflows to accommodate the functioning of the system. The tracking engine (see also FIG. 6(a)) determines based on inbound data where the click/user/information came from. Based on inbound data it determines how the source of that data should be attributed.

FIG. 6(a) shows tracking engine flow; Grape Asset, Harvester Asset, or Customer asset interact with something on social media or the net, and are redirected into the vineyard platform. At that point the tracking engine 601 takes in user data such as origin or social media platform, cookie data, IP address, etc. This is fed into the Tracking DB 602, and then operation DB 603, takes over tracking what asset (customer, grape or harvester) does on the site itself in terms of interaction. These can be actions like clicking on a job, posting a job, connecting a social platform service etc. All actions performed on site or in application are stored in operation DB 603. Data is combined by the task engine, this is a process such as deduplication of clicks, or jobs, etc. to ensure data is accurate. This occurs in 604. Data is then combined and pushed into the Reporting DB 605, and then is transformed in 606 to be displayed to the customer asset for their reporting (606 refers to the front end, or reporting engine) dashboard. Similarly this is presented to the harvester asset in 606 in the form of their harvester fund.

FIG. 6(b) shows reporting database workflow; Cassandra tracking DB takes in data from origin of harvester or grape asset, this is our tracking DB. Cassandra is tracking the unique URL of the harvester asset, or customer assets that they share to varying social media platforms. The origin like social media resource; it gets this from the browser data. Ips, unique URL, anything that is associated with data that we send out during distribution. This all occurs at the tracking DB 611. Cassandra makes the connection between the harvester asset or customer asset, and the grape asset that clicks on their post on social media. It does this by referencing the values in the URL to determine which job, from which social media platform, which harvester asset or customer asset posted it, and which customer asset that post belongs to. The second half of this process is the Operational DB. The operational DB 612, takes over once grape, customer, or harvester asset are on the vineyard website. Cassandra is not tracking what the user does on site, the op DB is 612. Based on what the customer asset, grape asset, or harvester asset does within the platform while on the site, opp ETL 613 (also FIG. 6(a)) will combine data in task engine (see also FIG. 6(c)), that will go back to our tracking DB Cassandra 614, also FIG. 6(a), which is combination of data through ETL, to reference what grape asset, harvester asset, or customer asset did on site, as well as source of user data from origin point. Then data is combined and sent to reporting engine (see also FIG. 6(b)), 615 and is delivered to the customer asset 616 or harvester asset 617 based on data relevant to them and their login within platform.

FIG. 6(c) shows task database workflow; Task DB is simply running each day to combine the data that is external data we take in. This is data that comes in from the Grape asset, customer asset, or harvester asset. This data could be things like the harvester asset applying for a job, or clicking on a link from social media to redirect to the site. This data could be a grape asset doing a similar function by redirecting to site, or applying to job. The task DB takes this data that comes in through tracking DB 621 and op DB 622, and combines to send into the next tracking DB 624. When harvester asset creates a post or customer asset creates a post and puts it on a social media venue, a unique hyperlink is created as an example. Once a grape asset interacts with this they will be redirected to platform. Once redirected Cassandra tracking DB 601 will intake information about origin, and link to proper job in platform. Once harvester or grape asset are on platform, op DB 622 is tracking their actions in platform. Task engine 623, runs to combine these actions, which is our task workflow. Then will post back to tracking engine Cassandra 624 which will inform reporting engine 625 (see also FIG. 6(b)) what to display to the customer asset 626 and 627 in their reporting.

Referring to FIG. 6(b), operation of reporting database 130(b) workflow is illustrated. The tracking DB 130(c) takes in data from origin of user, this is our tracking DB. The tracking database 130(c) tracks the unique URL of the harvester 20, origin like Facebook. It gets this from browser data, IPs, unique URL, anything that is associated with data that we send out. The tracking database 130(c) makes the connection between the harvester and the grape that clicks on their job. The second half of this process is the Operational DB. The operational DB takes over once the candidate asset 30 is in vineyard (i.e., in the system). The operational database (not the tracking database 130(c)) tracks what the user does on site. So, once the user is on site, the tracking database 130(c) stops, and the operational database starts. Then based on what the user does in UI, ETL will combine data in the task engine 116 (see also FIG. 6(c)), that will go back to the tracking DB 130(c), which is combination of data through ETL, to reference what user did on site, as well as source of user data from origin point. Then data is combined and sent to the reporting engine 112 (see also FIG. 6(b)), and delivered to the customer 10 or harvester 20 based on data relevant to them and their login within platform.

FIG. 6(c) shows operation of the Task DB Workflow. The Task DB is running each day to combine the data that is external data we take in. This is data we send out. So when harvester asset creates a post or customer asset creates a post and puts it on social media, a unique hyperlink is created as an example. With that data is also stored things like a job reference for customer, and their job etc. Once a grape asset interacts with this they will be redirected to platform. Once redirected Cassandra tracking DB will intake information about origin, and link to proper job in platform. Once user on platform, op DB is tracking their actions in platform. ETL runs to combine these actions, which is our task workflow. Then will post back to tracking engine (see also FIG. 6(a)) Cassandra which will inform reporting engine (see also FIG. 6(b)) what to display to the customer.

FIG. 6(b) shows the reporting DB workflow. The Cassandra tracking DB takes in data from origin of user, this is our tracking DB. Cassandra is tracking unique URL of the harvester, origin like Facebook. It gets this from browser data. Ips, unique URL, anything that is associated with data that we send out. Cassandra makes the connection between the harvester and the grape that clicks on their job. The second half of this process is the Operational DB. The operational DB takes over once a grape asset is in vineyard. Cassandra is not tracking what the user does on site, the op DB is. So, once the user is on site, Cassandra stops—Op DB starts. Then based on what user does in UI, ETL will combine data in the task engine (see also FIG. 6(c)), that will go back to our tracking DB Cassandra, which is combination of data through ETL, to reference what user did on site, as well as source of user data from origin point. Then data is combined and sent to reporting engine (see also FIG. 6(b)), and is delivered to the customer or harvester based on data relevant to them and their login within platform.

FIG. 6(c) shows the task Engine workflow. Task Engine is running each day to combine the data that is external data we take in. This is data we send out. So when harvester asset creates a post or customer asset creates a post and puts it on social media, a unique hyperlink is created as an example. With that data is also stored things like a job reference for customer, and their job etc. Once a grape asset interacts with this they will be redirected to platform. Once redirected Cassandra tracking DB will intake information about origin, and link to proper job in platform. Once user on platform, op DB is tracking their actions in platform. ETL runs to combine these actions, which is our task workflow. Then will post back to tracking engine (see also FIG. 6(a)) Cassandra which will inform reporting engine (see also FIG. 6(b)), what to display to the customer.

FIG. 1(b) shows one illustrative example embodiment of the hardware schematics for the system 5. The system 5 includes a front end, back end, and SQL database 130. The front end includes a processing device 101, such as a computer or server. Customers 10, Harvesters 20 and Applicants 30 enter information into the system 5 via a respective Customer portal 102, Harvester portal 104, and Applicant portal 105. As shown, the Customer, Harvester and Applicant portals 102, 104, 105 can be a processing device, such as a computer or a smart phone. The Customer, Harvester and Applicant portals 102, 104, 105 are in electronic communication with the front-end processor 101, such as wired, wirelessly or via a local or global the Internet, and for example the portals 102, 104, 105 are controlled by the user to access a web site controlled by the front-end processor 101.

Thus, the portals 102, 104, 105 transmit information to the front-end processor 101, such as Customer data, job listings, and the like, for example by the user entering data into a form on the website that is accessed by and displayed at the portal 102, 104, 105. In addition, the front-end processor 101 transmits information to the portals 102, 104, 105, such as Customer data, job listings, and the like.

The database 130 can be, for example, a SQL database, and can include a Harvester database table 132 and a Customer database table 134. The Harvester database table 132 contains information on the Harvester's social media sphere of influence. The Customer database table 134 contains information on jobs, Applicants, and Customer social media sphere of influence. The front end processor 101 communicates with the SQL database 130 to update and retrieve information from the tables 132, 134 via the backend, such as an artificial intelligence engine, reporting engine (see also FIG. 6(b)), and application server.

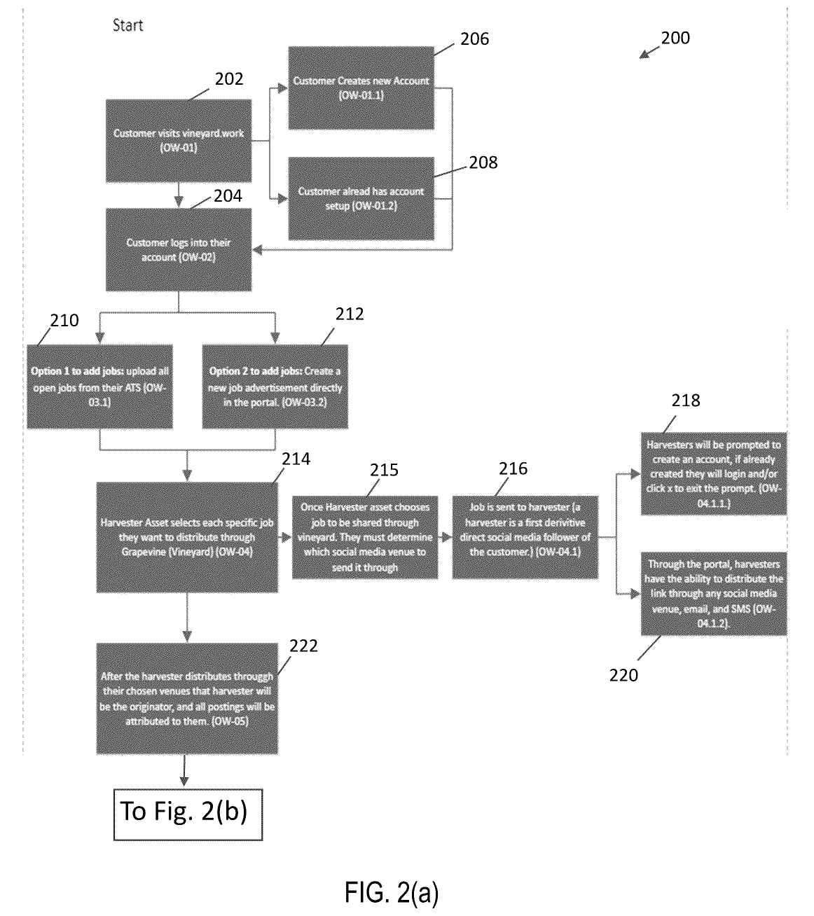

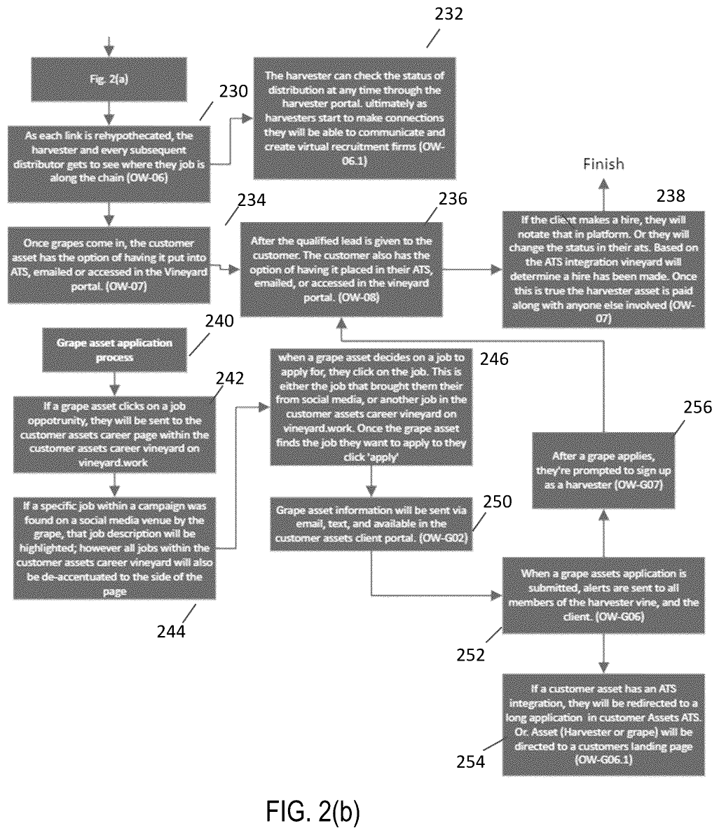

FIGS. 2(a), 2(b) illustrate operation of the system 5 in accordance with a non-limiting example embodiment of the disclosure. Operation begins when the Customer 10 visits the Customer portal 102 and accesses a target website, step 202. The Customer either creates a new account, step 206, or has an account, step 208, and logs into the account, step 204. Information regarding the account can be stored in the storage device 130, such as at the application database 130d. Once the Customer 10 has logged into its account, the Customer 10 can view all listings, such as job opportunities, add listings either by uploading all open listing opportunities (e.g., jobs) from their ATS or a feed (e.g., XML, CSV, Excel, URL), step 210, or to manually create a new job listing directly in the portal, step 212. The Customer user 10 can also select to view the Applicant Database 130d, which is a repository that houses all candidates 30 that have ever applied to an open or closed job, step 210.

Each job listing has job listing data that includes job detail data, as well as ATS integration details data. For example, the job detail data can include job title, major category, minor category, job description (e.g., based on a template or free form), requirements, work schedule (e.g., full time, part time, contract, gig), pay/salary information, benefits, (e.g., health), location, role location (e.g., remote or in person), and/or resume option. Other job listing data can also be provided, including for example, contact information, prepared asset questions and answer key, the number of positions that are available, and the number of hires needed. The system also assigns a create date to the job listing data, and job status (e.g., active, archived, completed, paused, deleted), as well as number of Applicants received, number of hires, and percent to goal. Job detail data are received via integration to the client's ATS.

The ATS 52 can be a third-party software, for example, and the present system is integrated into the Customer asset's ATS so there is a seamless pass-through of any information filed out through the system 5 (e.g., at the Customer portal 102) and there is no need for the candidate asset 30 to sign into the ATS. The number of hires made is the actual Applicants that are offered and accept a job. The number of open positions is the number of positions the Customer 10 is looking to fill. For example, a Customer 10 can need 500 warehouse workers but has only hired 100, thus there are 400 open positions remaining received.

Job listings are created by the Customer 10, step 212, using the Customer portal 102 and stored as a Client Table or Customer Database Table 134 in the Database 130. Object storage 130a is where the system ingests data web and otherwise in at first. It's a data storage architecture for storing unstructured data. It sections data into units or objects and stores them in a structurally flat database. The reporting database 130b stores data specific to reports. The tracking database 130c stores data specific to tracking, e.g. API data received from Facebook, or Twitter and or Pixel data where applicable. The Application database 130d stores application based data, so data generated by vineyard logs and the like. The databases 130 contain the data used to create all of the data a harvester 20 would access, and table 132 is a specific table within the database 130. Basically all of these things makeup our overall structured data, these are the initial receptacles which are ultimately stored in our mysql database for adhoc access. The Customer table 134 stores all information related to a Customer, including for example, data related to the Customer assets identification, including address, contact, no billing or sensitive information is stored. The Customer data identifies the Customer asset 10 and links to reporting by a unique ID stored in the table index.

The ATS 52 operations are controlled by the ATS controller 120, and stored in the application database 130d. The integration details vary by ATS and Customer asset, and each Customer 10 may have its own unique set of requirements. Each Customer asset 10 is stored in the Customer table in the application database 130d in a table related to Customer assets, with a Customer primary key or ID that identifies them. This Customer ID is linkable to other tables in the database 130, such as a campaigns table, and a jobs table. Customer table would be things relating to customer assets e.g. customer name, address, id, etc. and in the case of jobs, it is to say that we store all customers jobs in a table within our database, and they're linkable to the customers id on the customer table. The tables are used to house information relating to the customer assets jobs, and the customers information within the system. In one embodiment, no billing info etc., or information that would require extra security. Each table has a subsequent Customer ID listed on it, which refers back to the Customer asset table 134 and allows linking to be done.

The Customer user 10 can also select to use a Reporting Macro at the Reporting Engine 112 (see also FIG. 6(b)). Reports can be generated containing relevant data and metrics for each job and the campaign as a whole. The Reporting Engine 112 (see also FIG. 6(b)) can include a click house which generates reports based on data it receives from the MySQL Database 130 (FIG. 1(b)). The MySQL DB 130 receives data from the web via api, as well as from the candidate asset 30 and Harvester portal 104 for the Harvester asset 20. Both simply index data and show to the Customer asset. Data it outputs is things like shares, likes, applies, clicks. A report is generated to help Customer/admin know what is working.

If the Customer 10 decides to utilize its own social media, it indicates which social media platform that job listing is to be distributed through, step 214. The Task Engine 116 (see also FIG. 6(c)), handles launching the job listing. Data is pulled into the Tracking database 130c from the system UI, then sent to the MySQL DB 130 (the tracking database 130c is part of the MySQL database 130). Data stored is information about the job posting such as number of hires needed, Harvesters rehypothecating, all information related to the job. The Customer selects a job to launch at a time, they do not launch multiple. The Customer 10 can choose to post the job directly to the Customer's social media account.

The Harvester and Applicant assets 20, 30 can browse jobs via the links shared by the Customer asset, including details of the deal. Potential distributor/Harvester users 20 can sign up for platform access and share the link for profit, steps 214, 222. An originator Harvester is the first Harvester to distribute a job listing. A first derivative Harvester is the second person to look at the original Harvester assets links. Once a Harvester asset chooses a job and posts to social media venues they have given system authorization to post to, step 215, the 250 characters and a bitly link is sent, the script is determined by Customer in some cases, and in some cases Harvester can write freely.

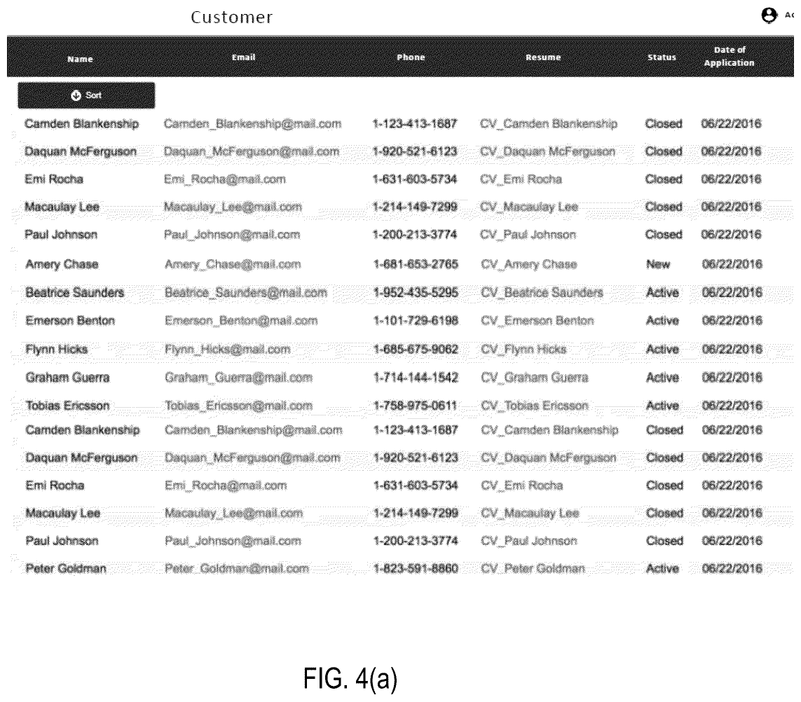

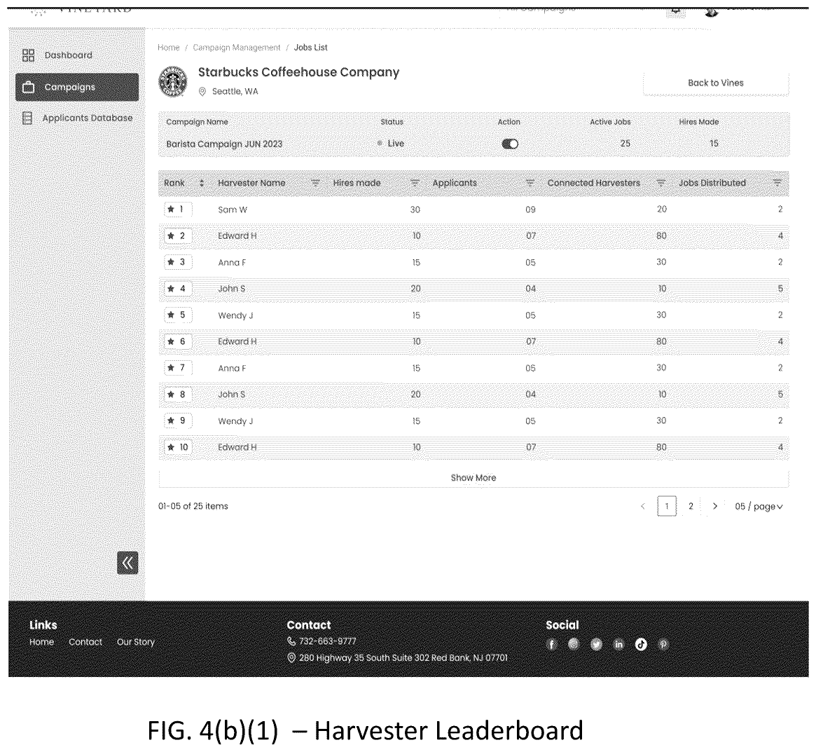

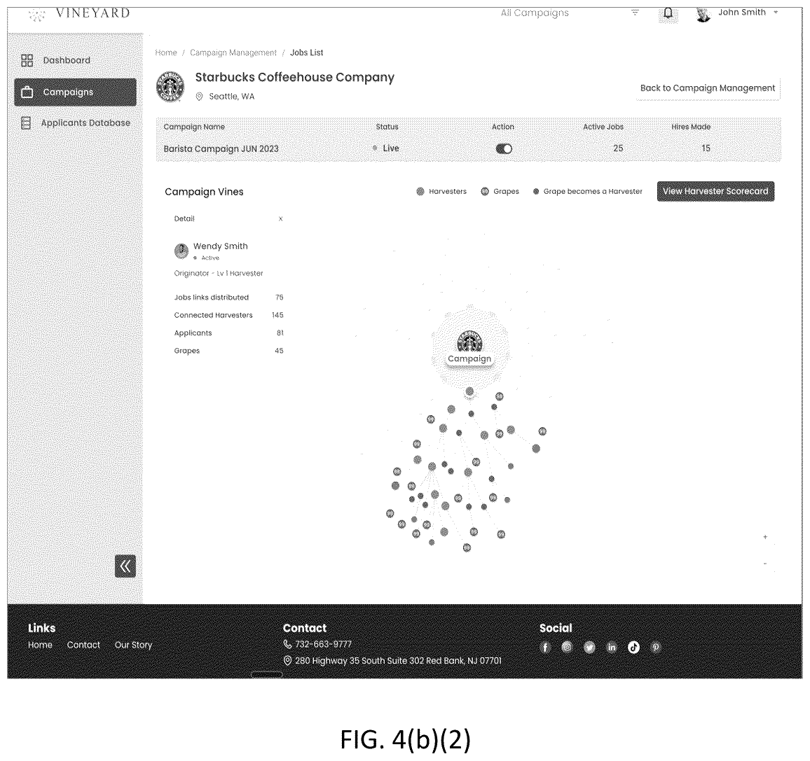

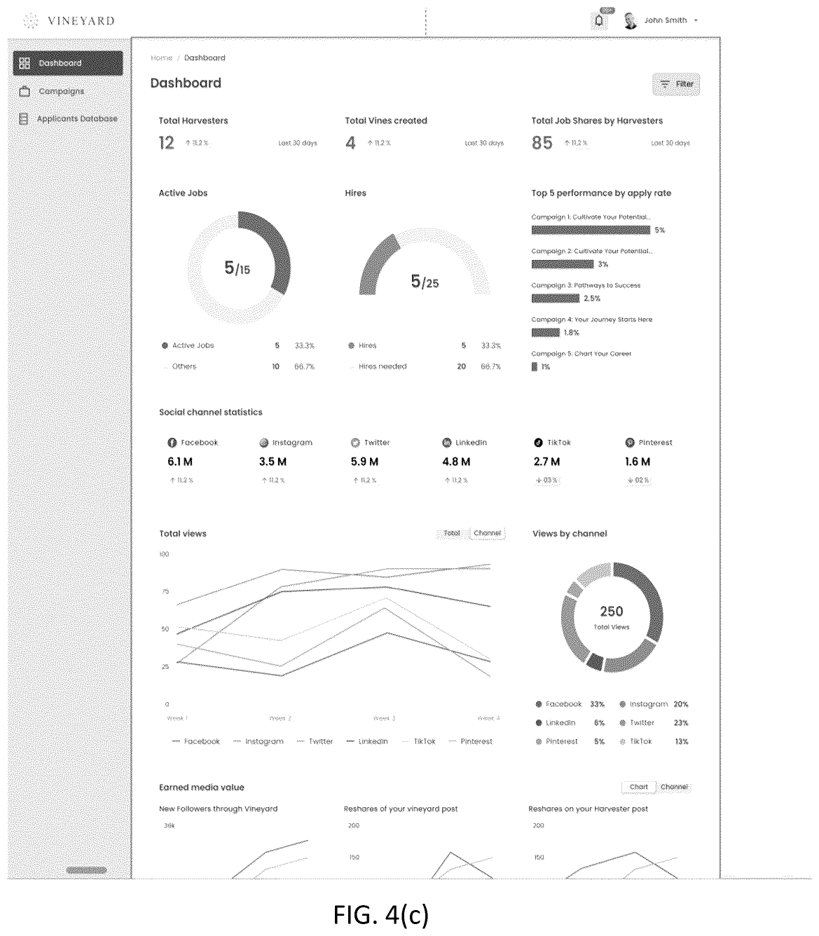

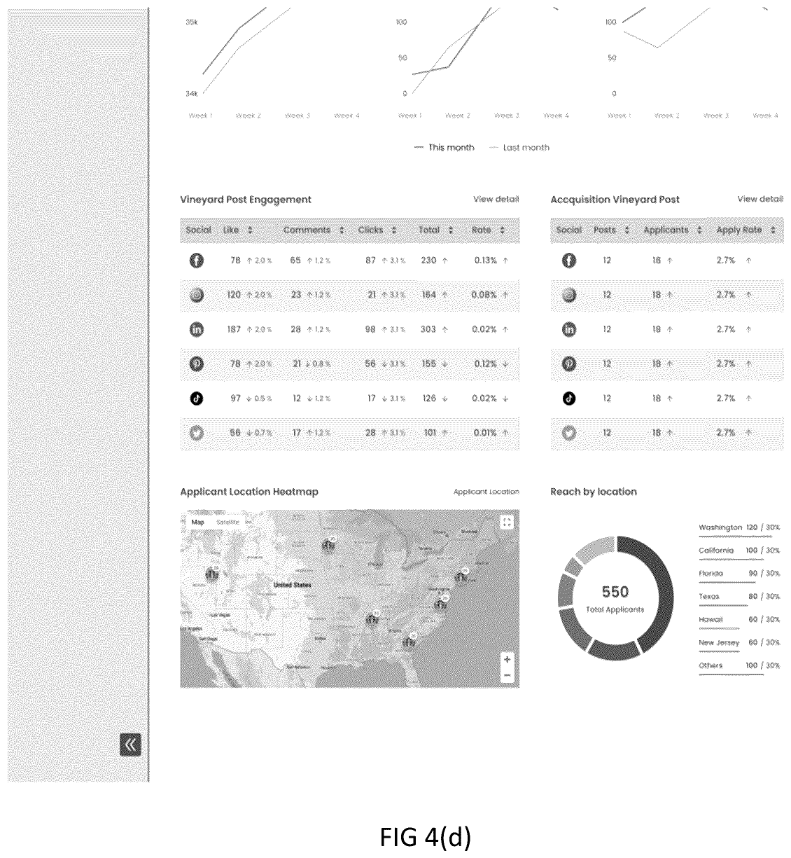

The controller 120 handles the launching of job listings. The information stored is stored in the App DB 130d, the information stored is related to original Harvester asset, Applicant asset, and Customer asset as well as the job that the Customer asset shared, the Harvester asset rehypothecated and the Applicant asset applied to. Reports are updated with relevant data, including for example that clicks, shares and applications are tracked and reported. The Reporting Engine 112 (see also FIG. 6(b)), can generate Reports that contain, applies, hires, commission, spent, implied cost per hire, average cost per hire, number of rehypothecations, implied reach, and impressions. The reports inform Customers and Harvesters where they are in terms of performance. A report is shown, for example, in FIG. 4(c).

Once a candidate 30, via the candidate portal 105, clicks on a job link distributed by a Harvester asset 20, the candidate 30 is automatically directed to the system portal to fill out basic information and then is sent (if the Customer asset selects this workflow) to their ATS (Applicant tracking system.

Unique links associated with the job(s) and/or the Customer career vineyard are created and stored in the Customer Table of the database 130. The Customer career vineyard is a list of all of the Customer assets available jobs that they are posting in the system. The Customer career vineyard can be stored, e.g., in the Customer DB, and is composed of all of the customers jobs that are presently live on vineyard. This list can be accessed by a Harvester asset to select job assets to rehypothecate, once they're registered as a Harvester asset. Or, this can be accessed by the Applicant asset when they view either a Harvester assets job asset that has been rehypothecated on Customer assets behalf, or the Customer asset has posted a job on their social media via our system and the Applicant asset has accessed it. In either case the Applicant asset can view all of that Customer assets job assets only, or the other job assets the Harvester asset has available.

The Customer 10 can also send (e.g., via email, text, social media messaging or posting on a storyboard, or the like) the job directly to a selected distributor user 20, either manually or utilizing artificial intelligence to determine the best distributors 20 that fit the job. It is distributed through the system to social media. This is done when the Harvester asset gets the Customer assets job asset, and determines that they want to rehypothecate. They give authorization to the system, and the system posts it through various social media apis. If the job is sent to a Distributor/Harvester user 20 without an account, the Distributor user is prompted to create a new account upon logging in, step 218, 220. Account details will be obtained including Username/Password and payment information, and whether the user is a Customer or Harvester (or Applicant in some embodiments), which is stored via different user types in the database, its numeric 1, 2, 3, etc.

Harvester information may include first name, last name, email, phone, city, state, postal, jobs that they have chosen are linked to them as well, and the jobs relevant information. This is all stored throughout tables in the MySql DB or reporting DB, and associated with a Harvester ID and stored in the user's table 130c Tracking DB all inbound data is here first this is ‘cassandra’ then it is sent to the application database 130d, which is MySQL. Reports are generated/updated regarding the new campaign for the Harvester 20, and updates on the Customer reports are updated with the new Harvester information. After the Harvester asset adds a job to their inventory, all relevant statistics are updated. For example, at first the job would show in their reporting macro with no information. No clicks, no impressions, etc. As clicks/impressions/applies come in, the numbers will update based on information received from the tracking database 130c, and stored in the reporting database 130b.

The Harvester/distributor 20 decides which jobs to distribute, and shares the job via their selected social media venues, step 215, the links are able to be rehypothecated and each degree of separation from the origin is tracked. They're able to distribute to whichever social media platforms we're integrated with (e.g., Facebook, LinkedIn, TikTok, Instagram, YouTube, Twitter), FIG. 2(b), steps 230-238. Links are generated by finding one of the Customers jobs in their career vineyard 214-222, FIG. 2(a), a registered Harvester can choose to ‘rehypothecate’ a job. Once selected, we take the original job, and create a unique link with named parameters like Harvester_id appended to them. This allows us to track the Harvester. Thus, rehypothecated is used here to mean that the original job can be reshared or ‘rehypothecated’ by a Harvester after the Customer creates it and posts it to their career vineyard, FIG. 3(b), which is where the harvester asset 20 or candidate asset 30 would land depending on what they interact with. They either (a) interact with the customers post on a social media venue, and are redirected to something like FIG. 3(b) that houses all of customers jobs on their ‘career vineyard’. Or (b) they do the same process, but it's a mix of jobs and companies on the harvester assets career vineyard.

Reporting is updated each time a link is clicked, shared or rehypothecated, and with each application that is filled out and submitted. After the Harvester asset adds a job to their inventory, we would update all relevant stats as they came in. Meaning at first the job would show in their reporting macro with no information. No clicks, no impressions, etc. As clicks/impressions/applies come in, the numbers will update based on information received from the tracking database 130c (FIG. 1(a)), and stored in the reporting database 130b.

At step 216, job listings are sent to the Distributor 20, via the Harvester portal 104, which is a first derivative direct social media follower of the Customer. At step 218, Harvesters are prompted to create an account or, if an account is already created, to login. At step 220, through the Harvester portal 104, Harvesters can distribute the link through any social media venue, email and SMS. Thus, a Customer asset 10 creates a job and posts it to their career vineyard, which is both in platform and on social media. If the Harvester asset 20 is following the Customer asset 10, the Harvester asset 20 will see the job in their feed, step 216. If the Harvester sees the job listing in their news feed on any social network we're integrated with, they will be able to interact with it. Step 216 is about them finding it, redirecting into vineyard, and choosing to rehypothecate the job. If they are an Applicant asset 30, when they find the Customer asset 10 job listing on social media, they'll be directed to create an account in step 218. After that, they can choose to rehypothecate once they are registered as a Harvester asset. That then leads back to step 222.

At step 222, after the Harvester distributes through their chosen venues, that Harvester is the originator, and all job listing postings will be attributed to them. Job listings are tracked by the Tracking Engine 110 (see also FIG. 6(a)), for example via a javascript pixels placed on the Customers assets landing page (controlled by a third party) or clients ATS (controlled by a third party). Pixel information is stored at the tracking database 130c, FIG. 1(a).

If a Harvester asset 20 is the first one to rehypothecate a Customer asset 10, they're by default ‘originator Harvester.’ If they are a Harvester that was created as a result of Harvester asset rehypothecation, they receive classification of Harvester. They do not track job listings, but instead they track conversions that happen on places off platform that are controlled by Customer asset either an ATS, or a landing page.

At step 230, as each link is rehypothecated, the distributor and every subsequent distributor gets to see where the job is along the chain. For example, at step 232, the Harvester can check the status of distribution at any time through the Harvester portal 104, i.e., if a job listing is posted, awaiting to be posted, paused, archived, etc. Ultimately, as Harvesters start to make connections, they can communicate and create virtual recruitment firms. A Harvester that has a group of other Harvesters they work with that allows them to share commissions, and rehypothecate as a group.

When a link is followed via social media, or from an SMS/email message, the potential Applicant 30 is brought either to the external career vineyard or directly to the job suggested for them. The Customer 10 and if applicable, the Harvester(s) 20 are notified via their selected venues of a new Applicant submission through the communication services. They will be presented with a short form application that is collected by the system, and if applicable, a long application on the Customer ATS is presented upon completion of the short form. Upon leaving the platform for an ATS Application, tracking pixels are utilized to follow the process along multiple steps from opening the application until the application is submitted. Reporting is updated when an application is submitted. A new Applicant is created and committed to the Customer Database containing all relevant information. To track for notification, the Customer places a pixel or multiple pixels on their ATS or landing page. Once the pixel fires based on parameters in the URL, we know which Harvester asset, Customer asset, and their job asset to link the conversion to. Pixels are created to track different stages of the process, so there will be specific pixels for specific things.

At steps 234, 236, 238, when an asset 30 is acquired (e.g., a hire is made), payment is processed and all parties involved in finding the Applicant are compensated according to the details of the campaign. At step 238, payment is made by the customer 10 to the harvester 20. Once customer has hired grape asset, harvester asset, and any other harvester asset involved in the process of obtaining that hire will be paid. If hiring needs are met, the job is closed and no further applications can be submitted. Existing links are redirected to the Customer's career vineyard. The App DB and Tracking DB determine if hiring needs are met Reporting is updated for both the Customer and the Harvester(s) to reflect the new hire. Thus, at step 234, once an asset is acquired, the Customer has the option of having it put into ATS, emailed or accessed in the Customer portal.

This is tracked via the Applicant asset 30 answering short forms that relate to the job asset. A job listing can have a distinct URL for each Harvester asset that is linked back to a reference_id for the Customer assets job. This allows us to track which Harvester assets 20 provide Applicant assets 30 to the Customer assets job asset 10. Data is stored based on the fields that they fill out, so any custom questions the Customer asset asks on their job asset, the Applicant asset, or Harvester assets contact information. Data is stored in the Applicant database 130d. The information stored is in multiple tables relating to Customer asset, campaign asset, job asset, Harvester asset, and Applicant asset. All of these items and relevant information to the job asset will be stored into the Applicant database 130d.

Continuing at step 236, once the qualified lead is given to the Customer (e.g., through the Customer portal 102) and a hire is made, it is tracked. For example, if a hire is made a signal is returned based on what is done in the ATS, if the integration allows, and the system 5 will know that a hire is made as it will return information to the system 5 based on information we send. For example, a first Applicant asset 10 may have a unique Applicant ID, let's say of 1234. The ATS returns a ‘status’ signal to the controller 100 that tells the controller 100 that the first Applicant is ‘hired’, ‘in process’, ‘interviewed’, ‘rejected’ or any other status that it can return. This is just a data point stored in AppDB 130d and received at the backend of the system from the ATS and communicates directly via api with App DB 130d and stored at the AppDB 130d.

A “qualified” lead means that the Applicant asset 30 or Harvester asset 20 has answered the questions correctly. There are questions that the Customer asset can create on their job asset that can be a ‘qualifying’ question, as in if the Harvester or Applicant asset answers the question incorrectly, they're ‘disqualified’ similarly . . . if they answer the question ‘correctly’ they're ‘qualified.’

The commission dollars are then sent to the distributor (e.g., through the distributor portal 104), step 238. Once the Harvester asset ‘rehypothecates’ a job, the vineyard will allow them to choose which venue they want to share it on, based on the integrations we have. Once they choose the venues, they give us an authorization to post to their account on their behalf and the vineyard distributes. The commission is sent via a payment portal.

At step 240, the application process followed by the Applicant asset (e.g., through the Applicant asset portal 106) is shown. At step 242, once the asset clicks on an opportunity (e.g., a job opportunity), the asset portal 106 is directed to the company's career page within the career vineyard website. Job listings can be posted on the website when a Customer asset creates a job listing. If a Harvester asset that is registered has an account, they can search those listings and view Customer assets career vineyard based on their interests. They give us their interests on registration, based on the major and minor categories we have available such as ‘transportation & logistics’, at the AppDB 130d. If a specific job within a campaign was sent to the asset user 30, that job description is highlighted. However, all jobs within the company 10 will also be de-accentuated to the side of the page, step 244.

At step 246, when the Applicant asset operator 30 decides on an opportunity (e.g., job listing) to apply for, the Applicant asset operator 30, via the asset portal 106, clicks on it, fills out a short form, and clicks on “submit application.” Applicant information is then sent to the asset user, such as for example via Email, text, client portal Applicant tab, step 250. When an application is submitted, alerts are sent to all members of the Harvester vine, and the client 10.

The members include Harvester Assets that generated the Applicant asset or an additional Harvester asset, as well as Customer asset and their assigned members to their account. Members are linked (i.e., associated with, for example by associating a member ID with the job listing) to a job listing which is linked to a Harvester or Customer asset, which is linked back to a campaign asset which is linked to a Customer asset. These are all stored in unique tables within the Applicant database 130d. Alerts are generated via e-mail through several services by the controller 120, primarily communication service. The “Harvester vine” shows all the Harvesters that are all sharing the job via the Customers portal. If the Customer has an ATS integration, they are redirected to a long application, step 254. The system opens a new window to redirect the candidate. After the candidate finishes their longform application, they are able to close that window and return to the system. After an asset operator applies, step 256, they are prompted to sign up as a Harvester user 20. The application process is tracked, step 236, and commissions are distributed, step 238.

Referring now to FIGS. 3-4, non-limiting, illustrative examples of the disclosure are shown. FIG. 3(b) shows the vineyard and FIG. 3(c) shows a zoomed in view post interaction with a job asset. FIGS. 3(a)(1), 3(a)(2), 3(a)(3) show a listing of job listing opportunities that are viewable by the Customer user 10. As shown, when the Customer user 10 selects to view job opportunities, the Customer user 10, via the Customer portal 102, is presented with a listing of the job opportunities that it has created or imported through its ATS. Each job opportunity is listed, as well as the opportunity status (e.g., active, archived, completed, paused, deleted), and whether or not sponsored. The user can view open jobs and/or closed jobs. FIG. 3(a) show how to access a job. So you′d need to click on one of these to determine if you wanted to adjust where to post it. It also shows where you choose on job creation where its available. After creating a job, or if you wanted to change venue how you would do that, FIG. 3(a)(2). FIG. 3(a)(3) shows the candidate list/applicant database.

The Customer 10, via the Customer portal 102, can select any of the job opportunities to see more detail and/or edit the job details, as shown in FIG. 3(b). The user can also search or filter jobs, such as by job type or date, or sort jobs, such as by the number of positions, number of hires needed, number of Applicants, number of hires, or percent to goal. Relevant job summaries are listed on the left column, and selected jobs are shown in more detail in the right column. The summary list and detailed list also show the status, as well as the number of distributors 20 that have distributed the job opportunity, the number of Applicants received, and the number of hires made.

The controller 120 calculates the number of Applicants, number of hires, and percent to goal, and when status changes. This is done as the system receives signals from the Customer assets ATS in the case of a long form apply, or when an Applicant or Harvester asset applies to a job listing directly. The controller 120 receives the statistics, stores the statistics in the database 130, and updates the user interface in real time or in near real time, such as for example within 2 minutes and the reporting macro for Customer to view. If the Customer user 10 clicks to see the Harvester vine (i.e., the distributors that have acted on the job opportunity), that information is also shown, as illustrated in FIG. 3(c). Here, the distributor leaderboard is shown, as well as details on the top few distributors, such as for example, number of job links distributed, connected distributors, number of Applicants, and hires made. This is determined by aggregating the statistics relating to the Harvester assets and their posts. For example: Harvester 1 has reshared the Customer assets job asset 1 time, they have generated 32 Harvesters, 52 Applicants, and made 2 hires; and Harvester 2 has shared the same job asset with their own unique link 1 time, they've created 20 Harvesters, and 26 Applicants and made 0 hires. Harvester 1 is determined to rank hire than Harvester 2.

Returning to FIG. 3(a)(1), the Customer 10, via the Customer portal 102, can then select each job to be distributed through the system 5. The Customer user 10 also, via the Customer portal 102, indicates which venues of distribution are to be utilized including, for example, to distribute directly through their own social media, and/or to distribute via Distributor users 20. If the Customer 10 decides to utilize its own social media, it indicates which social media platform that job is to be distributed through, step 214. The Customer 10 can choose to post the job directly to the Customer's social media account. The candidates (e.g., job Applicants 30) can browse jobs via the links shared by the Customer, including details of the deal. Potential distributor users 20 can sign up for platform access and share the link for profit.

FIG. 4(a) shows the Applicant Database having a list of job Applicants, namely the Applicant asset users 30 that have applied for the opportunity (e.g., job). The Applicant information is stored in the Applicant database 130d, and includes, for example, name, email, phone, resume, status, and date of application. As shown in FIG. 4(a), the user can select a name to view the Applicant information, distributor information 3(c), and number of connections 3(c) and 4(b)(2). A graphical representation of the distributors can also be shown.

FIGS. 4(c), 4(d) show a report generated by the reporting macro, which is activated when the Customer user selects to generate a report. The report includes various information, including a list of active and paused jobs, the number of applications this week, active job postings, and analytics. Also shown is the number of social media followers per social media platform, and other related social media data. The user can display the various distributors by hovering over or selecting a particular job opportunity. That information is determined by the reporting engine 112, (see also FIG. 6(b)) based on information stored in the database 130.

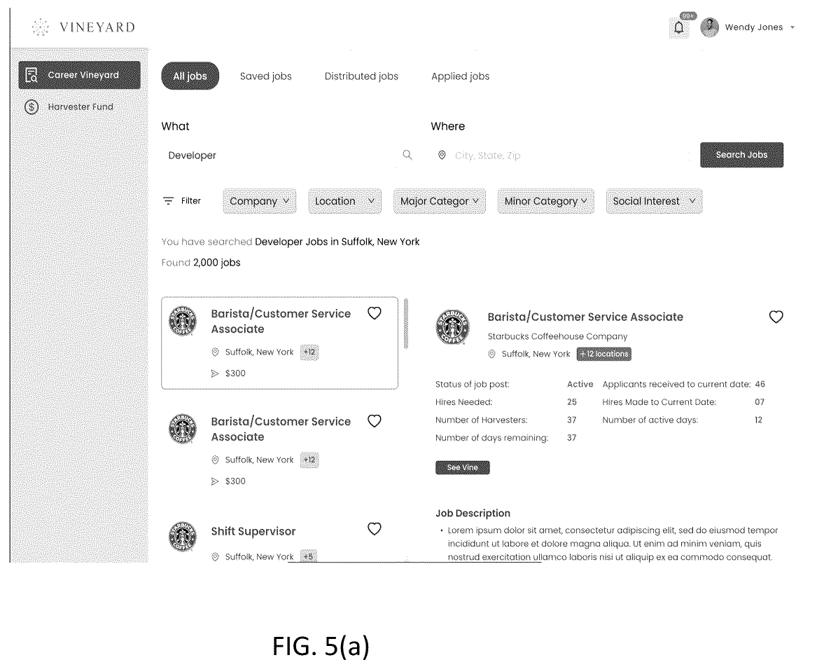

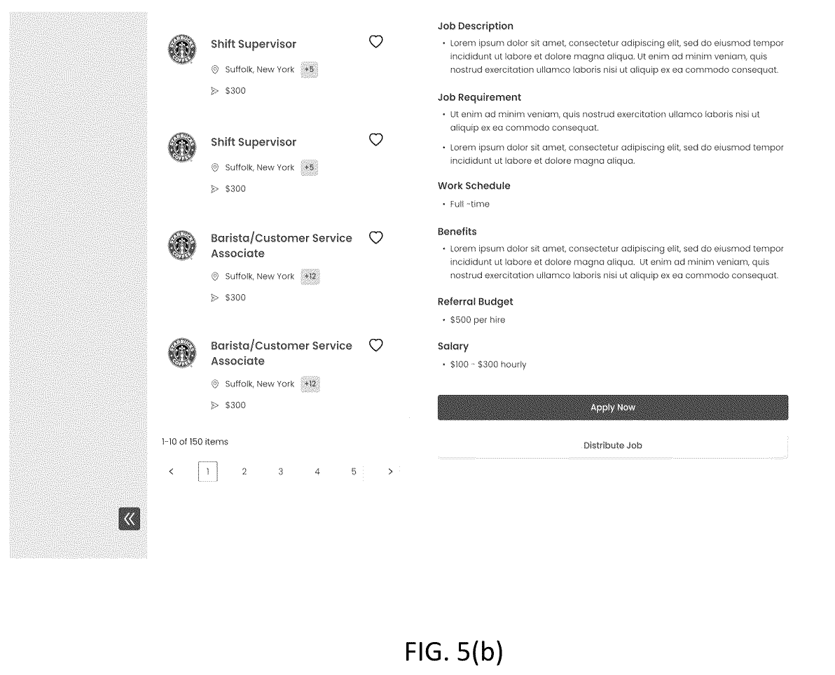

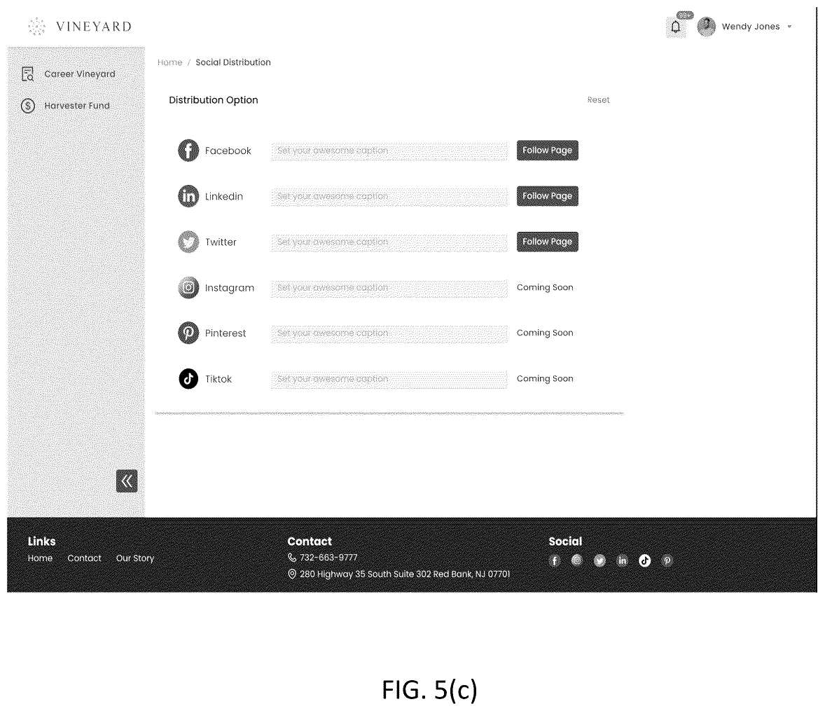

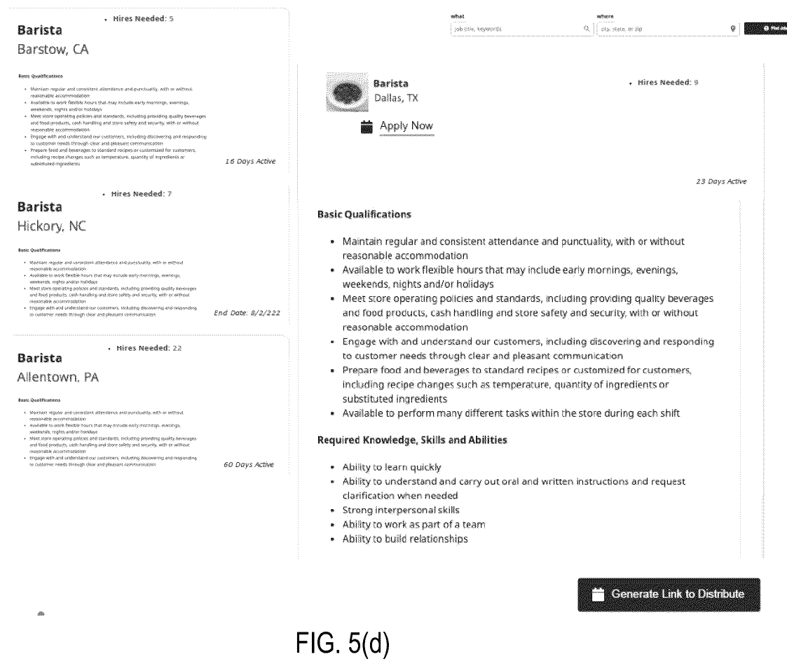

FIGS. 5(a), (b), (c) shows a screen illustrated to a distributor user 20 or an asset user 30, as viewed through the distributor portal 104 or the asset portal 105. All jobs can be listed, and narrowed by searching based on a keyword or a geographic location. Summary job detail information can be illustrated, and further job details presented when the user selects a particular job to view. The user can view more detail by selecting a desired job, and either apply for the job by selecting a link, or select to generate a link for distribution, FIG. 5(d). In some embodiments, the distributor user 20 and asset user 30 can see the same options to apply for a job or generate a link for distribution. If the user selects to apply for the job, certain information such as bibliographic information and a resume, can be retrieved from the user's account. The user is prompted to input any additional information. FIG. 5(b) shows the distribution button to generate links or distribute job, etc. In FIG. 5(c), once a harvester asset clicks to generate a link, provided they're registered completely, they'll be able to distribute after they follow the page, for example an automatic post to their social media page of choice.

In one embodiment, an automated referral tracking system and method are provided for a customer to track job applicants referred to the customer by referral sources. The automated referral tracking system includes a computer or cloud-based processing device that creates a customer account for the customer, where the customer account is associated with a job listing and social media accounts. It also creates and/or maintains a distributor account for each referral source. The job listing is posted, for example, from the customer's account to job candidates on vineyard or on social media venues and customer accounts on those venues. The system tracks distribution of the posted job listing to identify the distributor social media account or one or more social media accounts they have integrated that distributed the posted job listing. The system determines if a posted job listing has been filled by a job candidate and, once it has been filed, compensates each distributor account identified to have distributed the posted job listing filled by the job candidate or if the hire is made directly by vineyard platform customer pays vineyard all of the commission on the job. It will be recognized that the method and system need not include each of those features, for example, a customer account and/or distributor account need not be created. And the tracking can be done in any suitable manner other than as shown and described herein. In addition, the various accounts can be associated with a respective unique identifier. For example, each customer can have a unique customer account and customer ID associated with that account; each distributor can have a unique distributor account and distributor ID associated with that account; and each social media account can have a unique social media ID.

In certain embodiments, the automated referral tracking system can comprise a social media platform. In some embodiments, the job listed is posted to a social media platform. In some embodiments, the computer processing and cloud-based device creates the job listing. In some embodiments, distribution is tracked by pixels. In some embodiments, the customer account is associated with a plurality of job listings. In some embodiments, distribution is tracked to determine that a job application has been completed by a job applicant, that the job application has been submitted, and that the job application has been filled. In some embodiments, the computer processing or cloud-based device generates a report based on the tracked distribution. And in some embodiments, the computer processing device generates a report based on a status of the job listing, and other information such as for example, which referral sources have been compensated, how much they were compensated, the entire distribution trail.

It will be apparent to those skilled in the art having the benefit of the teachings presented in the foregoing descriptions and the associated drawings that modifications, combinations, sub-combinations, and variations can be made without departing from the spirit or scope of this disclosure. Likewise, the various examples described may be used individually or in combination with other examples. Those skilled in the art will appreciate various combinations of examples not specifically described or illustrated herein that are still within the scope of this disclosure. In this respect, it is to be understood that the disclosure is not limited to the specific examples set forth and the examples of the disclosure are intended to be illustrative, not limiting.

In certain embodiments, the system and method (e.g., the portals 102, 104, 106, as well as the main structure 100) can be implemented by one or more processing devices to perform various functions and operations in accordance with the disclosure, including to display the Vines or Vineyards to the user. The processing device can be, for instance, a computer, personal computer (PC), server or mainframe computer, or more generally a computing device, processor, application specific integrated circuits (ASIC), or controller. The processing device can be provided with one or more of a wide variety of components or subsystems including, for example, wired or wireless communication links, input devices (such as touch screen, keyboard, mouse) for user control or input, monitors for displaying information to the user, and/or storage device(s) such as memory, RAM, ROM, DVD, CD-ROM, analog or digital memory, flash drive, database, computer-readable media, floppy drives/disks, and/or hard drive/disks. All or parts of the system, processes, and/or data utilized in the system of the disclosure can be stored on or read from the storage device(s), such as the database(s) 130. The storage device(s) can have stored thereon machine executable instructions for performing the processes of the disclosure. The processing device can execute software that can be stored on the storage device. Unless indicated otherwise, the process is preferably implemented automatically by the processor substantially in real time without delay.

The system and method of the disclosure can also be implemented by or on a non-transitory computer readable medium, such as any tangible medium that can store, encode or carry non-transitory instructions for execution by the computer and cause the computer to perform any one or more of the operations of the disclosure described herein, or that is capable of storing, encoding, or carrying data structures utilized by or associated with instructions.

The processing device can also be connected to the Internet, such as by a wireless card or Ethernet card. The processing device(s) (e.g., the portals 102, 104, 106, as well as the main structure 100) can interact with a website to execute the operation of the disclosure, such as to present output, reports and other information to a user via a user display, solicit user feedback via a user input device, and/or receive input from a user via the user input device. For instance, the processing device can be part of a mobile smart phone running an application (such as a browser or customized application) that is executed by the processing device and communicates with the user and/or third parties via the Internet via a wired or wireless communication path.

The description and drawings of the present disclosure provided in the paper should be considered as illustrative only of the principles of the disclosure. The disclosure may be configured in a variety of ways and is not intended to be limited by the preferred embodiment. Numerous applications of the disclosure will readily occur to those skilled in the art. Therefore, it is not desired to limit the disclosure to the specific examples disclosed or the exact construction and operation shown and described. Rather, all suitable modifications and equivalents may be resorted to, falling within the scope of the disclosure

1. An automated referral tracking system for a customer to track job applicants referred to the customer by referral sources, said automated referral tracking system comprising:
a computer or cloud-based processing device configured to:
maintain a customer account for the customer, said customer account associated with a job listing and a social media account;
maintain a distributor account for each referral source;
post the job listing from the customer's account to job candidates on vineyard or on social media venues and customer accounts on those venues;
track distribution of the posted job listing to identify the distributor social media account or one or more social media accounts they have integrated that distributed the posted job listing;
determine if a posted job listing has been filled by a job candidate; and
compensate each distributor account identified to have distributed the posted job listing filled by the job candidate or if the hire is made directly by vineyard platform customer pays vineyard all of the commission on the job.

2. The automated referral tracking system of claim 1, wherein the system comprises a social media platform.

3. The automated referral tracking system of claim 1, wherein the job listed is posted to a social media platform.

4. The automated referral tracking system of claim 1, said computer processing and cloud-based device further configured to create the job listing.

5. The automated referral tracking system of claim 1, wherein distribution is tracked by pixels.

6. The automated referral tracking system of claim 1, wherein said customer account is associated with a plurality of job listings.

7. The automated referral tracking system of any claim 1, wherein distribution is tracked to determine that a job application has been completed by a job applicant, that the job application has been submitted, and that the job application has been filled.

8. The automated referral tracking system of claim 1, said computer processing or cloud-based device further configured to generate a report based on the tracked distribution.

9. The automated referral tracking system of claim 1, said computer processing device further configured to generate a report based on a status of the job listing.

10. An automated method for referral tracking for a customer to track job applicants referred to the customer by referral sources, said method comprising:
creating, at a computer or cloud-based processing device, a customer account for the customer, said customer account associated with a job listing and social media accounts;
creating, at the computer or cloud-based processing device, a distributor account for each referral source;
posting, at the computer or cloud-based processing device, the job listing from the customer's account to job candidates on vineyard or on social media venues and customer accounts on those venues;
tracking, at the computer or cloud-based processing device, distribution of the posted job listing to identify the distributor social media account or one or more social media accounts they have integrated that distributed the posted job listing;
determining, at the computer or cloud-based processing device, if a posted job listing has been filled by a job candidate; and
compensating, at the computer or cloud-based processing device, each distributor account identified to have distributed the posted job listing filled by the job candidate or if the hire is made directly by vineyard platform customer pays vineyard all of the commission on the job.

11. The method of claim 10, wherein the computer or cloud-based processing device comprises a social media platform.

12. The method of claim 10, wherein the job listed is posted to a social media platform.

13. The method of claim 10, further comprising creating, at the computer processing or cloud-based device, the job listing.

14. The method of claim 10, wherein distribution is tracked by pixels.

15. The method of claim 10, wherein the customer account is associated with a plurality of job listings.

16. The method of claim 10, wherein distribution is tracked to determine that a job application has been completed by a job applicant, that the job application has been submitted, and that the job application has been filled.

17. The method of claim 10, further comprising generating, at the computer processing and/or cloud-based device, a report based on the tracked distribution.

18. The method of claim 10, further comprising generating, at the computer or cloud-based processing device, a report based on a status of the job listing.
